(19) United States
(12) Patent Application Publication
(10) Pub. No.: US 2010/0122758 A1
(43) Pub. Date: May 20, 2010

(54) TIRE WITH FOAM PORTION AND RESILIENT PORTION

(76) Inventor: SHU-JU HUANG, Yuanlin Town (TW)

Correspondence Address: PHILLIP LIU, 6980, WHITEOAK DRIVE, RICHMOND, V7E4Z9, omitted

(21) Appl. No.: 12/275,200

(22) Filed: Nov. 20, 2008

(51) Int. Cl. B60C 7/00

(52) U.S. Cl. 152/157

(57) ABSTRACT

A tire includes a foam portion made of rubber or plastic material and foamed integrally to be a ring-shaped foam portion, and a resilient portion received in the foam portion and having a hollow space defined therein. The hollow resilient portion reduces the foam material required and provides proper resilient feature to keep shape of the tire.

### FIELD OF THE INVENTION

The present invention relates to a tire made by foam material and a hollow resilient portion is received within the tire.

### BACKGROUND OF THE INVENTION

A cart for transporting loads generally includes at least two tires which makes the heavy load be easily moved from one place to another. The conventional tire generally includes an inner tube and an outer tube which is made by rubber and the inner tube is filled with air so as to provide desired flexibility. However, the inner tube can be easily penetrated by sharp object and the air leaks and the tire becomes flat. Therefore, a solid tire made by rubber or foam material is developed and which does not reed to inflate and can be manufactured easily.

One conventional solid tire is disclosed in FIG. 10 and includes an outer portion 40 and an inner portion 41, wherein the outer portion 40 is made by rubber and the inner portion 41 is made by rubber or foam material. The solid tire has an inherent shortcoming that is the solid tire cannot bounce back so that if the solid tire is not used for a period of time, the solid tire becomes flat at the portion being in contact with the ground. The flat portion causes the solid tire to be deformed permanently.

Another conventional solid tire is disclosed in FIG. 11 and includes an outer portion 50, an inner portion 51 and a solid resilient portion 52 which is located between the outer portion 50 and the inner portion 51. The outer portion 50 is made by rubber and the inner portion 51 is made by rubber or foam material. The solid resilient portion 52 improves the shortcoming of the solid tire disclosed in FIG. 10, but the manufacturing processes are complicated and the cost is high.

The present invention intends to provide a tire made by foam material and a resilient portion is received in the foam material, the resilient portion includes a space defined therein so as to provide inner pressure to keep the shape and profile of the tire.

### SUMMARY OF THE INVENTION

The present invention relates to a tire which comprises a foam portion and a resilient portion, wherein the foam portion is made of rubber or plastic material and foamed integrally to be a ring-shaped foam portion, and the resilient portion is received in the foam portion and has a hollow space defined therein. The resilient portion allows the tire to be deformed when a force applied thereto and bounces back after the force is disappeared.

The primary object of the present invention is to provide a tire that is made by foam material and a hollow resilient portion is received in the foam portion so as to reduce the foam material needed and keep proper flexibility for the tire.

Another object of the present invention is to provide a tire that is made by foam material and a hollow resilient portion is received in the foam portion, wherein the resilient portion can have different shapes so as to meet requirements of different designs of tires.

Yet another object of the present invention is to provide a tire that is made by foam material and a hollow resilient portion is received in the foam portion, wherein the resilient portion includes multiple protrusions extending radially outward therefrom and each of the protrusions includes a hollow space defined therein so as to provide better bouncing features.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the tire of the present invention;

FIG. 2 is a perspective view to show the tire of the present invention, wherein a part of the tire and the rim is removed;

FIG. 3 is a cross sectional view of the tire of the present invention;

FIG. 4 shows that the resilient portion is deformed when a force is applied to the tire;

FIG. 5 shows that the resilient portion has an oval cross section;

FIG. 6 shows that the resilient portion has an elongate and curved cross section;

FIG. 7 shows that the resilient portion has multiple hollow protrusions extending radially therefrom;

FIG. 8 is a cross sectional view to show a second embodiment of the tire of the present invention;

FIG. 9 is a cross sectional view to show the second embodiment of the tire of the present invention wherein the resilient portion includes multiple radial hollow protrusions:

FIG. 10 is a cross sectional view to show the conventional tire, and

FIG. 11 is a cross sectional view to show another conventional tire.

### DETAILED DESCRIPTION OF THE PREFERRED EMBODIMENT

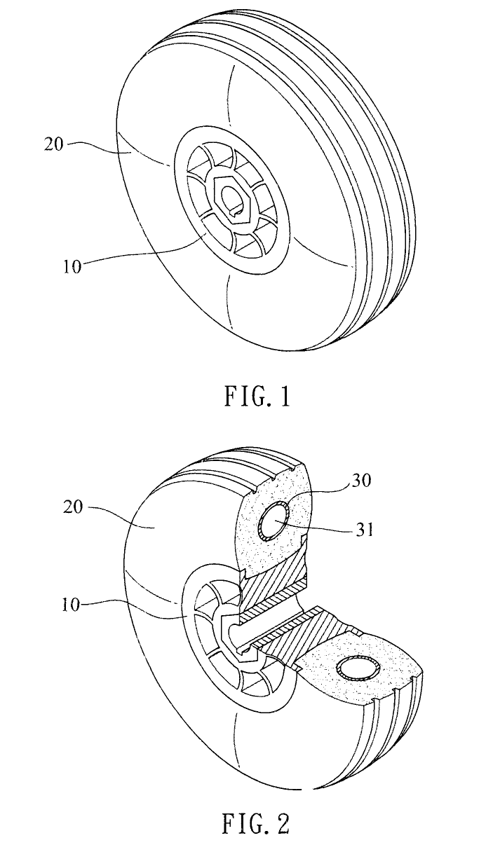

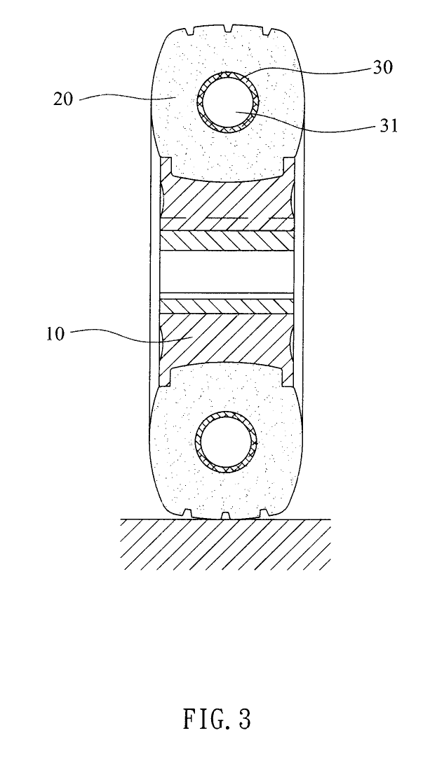

Referring to FIGS. 1 to 3, the tire of the present invention comprises a rim 10 and a foam portion 20 is mounted to the periphery of the rim 10. The foam portion 20 is made of rubber or plastic material and foamed integrally to be a ring-shaped foam portion 20. A ring-shaped resilient portion 30 is received in the foam portion 20 and has a hollow space 31 defined therein. In this embodiment, the resilient portion 30 has a circular cross section and is located at the center of the foam portion 20.

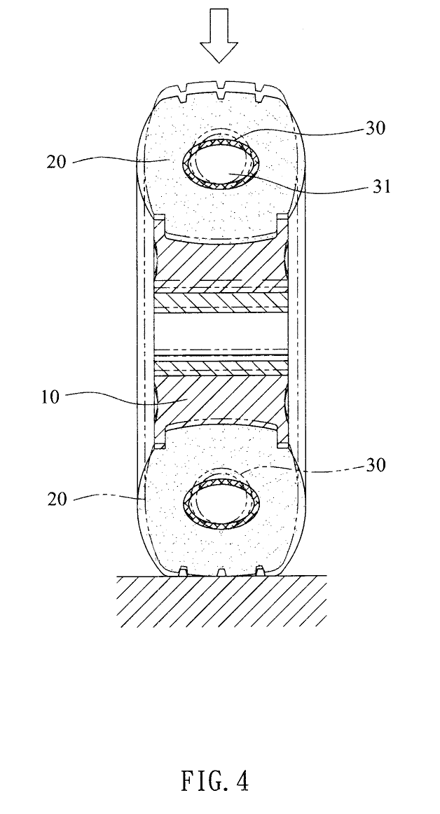

FIG. 4 shows that when a force as shown by the arrow head is applied to the tire, the foam portion 20 and the resilient portion 30 are deformed. After the force is disappeared, the resilient portion 30 bounces back and the tire can be kept as its original shape and profile.

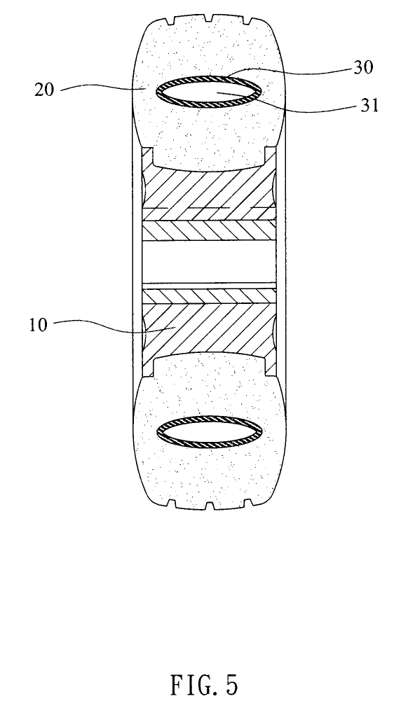

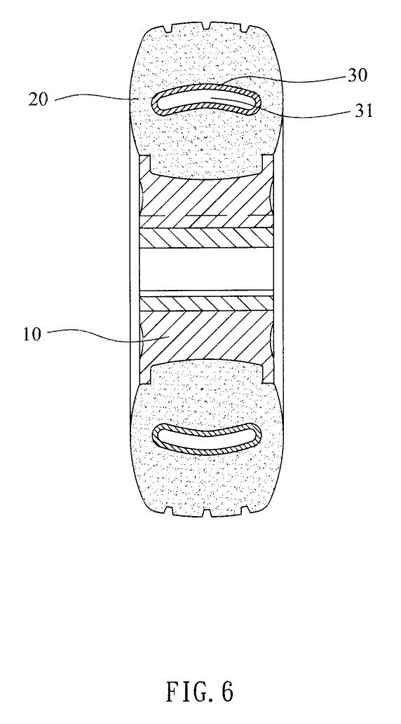

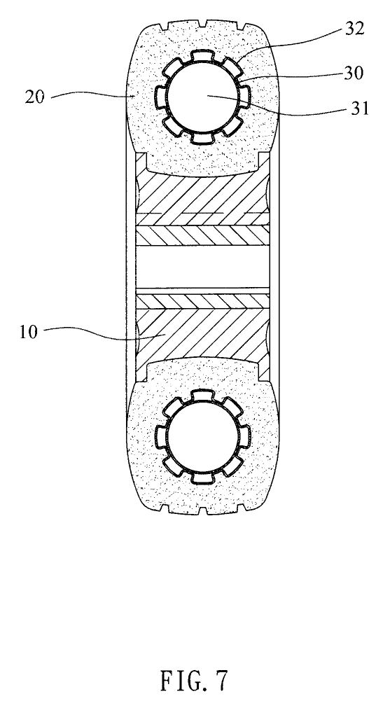

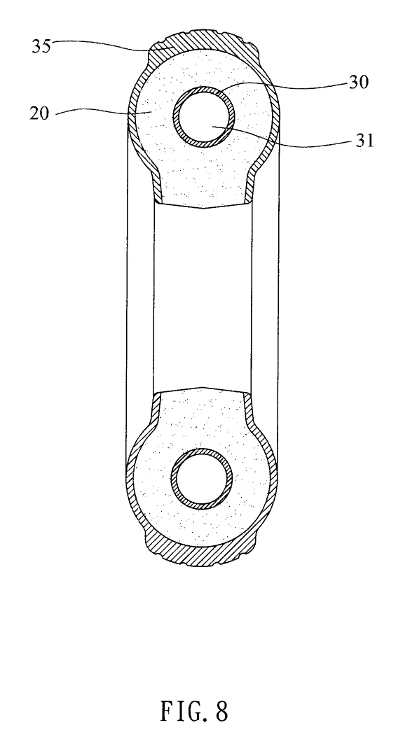

FIGS. 5 and 6 show that the resilient portion 30 can be an oval cross section and an elongate and curved cross section.

FIG. 7 shows that the resilient portion 30 includes multiple protrusions 32 extending radially outward therefrom and each of the protrusions 32 includes a hollow space defined therein. The multiple protrusions 32 are located at a distance and the foam material is filled in the distances between the protrusions 32. The hollow protrusions 32 provide better flexibility to the tire. The hollow protrusions 32 are individually defined and do not communicate with the hollow space 31 so as to individually perform the bouncing feature. The resilient portion 30 is made by rubber or thermo-elastic rubber.

FIG. 7 shows the second embodiment of the tire of the present invention, the difference from the first embodiment disclosed in FIGS. 1-7 is that a rubber portion 35 is located on an outer periphery of the tire and the foam portion 20 made of rubber or plastic material is received within a space enclosed by the rubber portion 35. The foam portion 20 is foamed integrally to be the ring-shaped foam portion 20 and the resilient portion 30 is received in the foam portion 20. The resilient portion 30 has a hollow space 31 defined therein. The resilient portion 30 has a circular cross section.

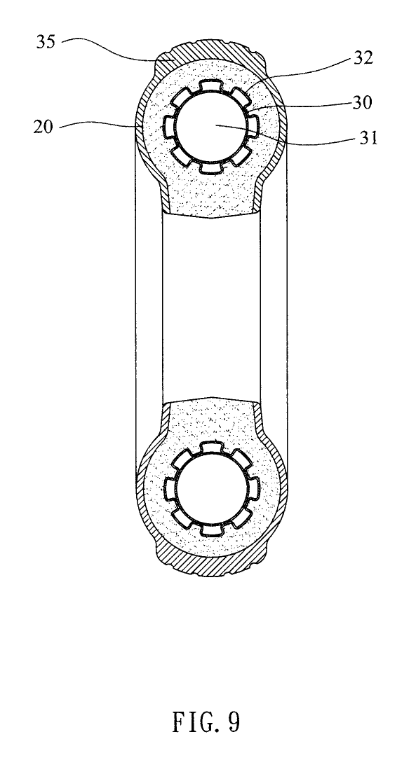

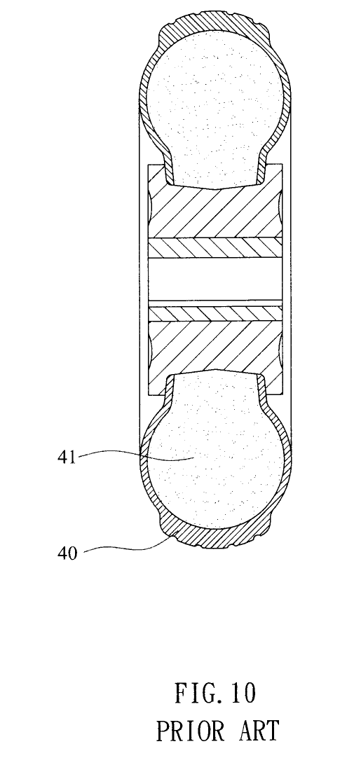

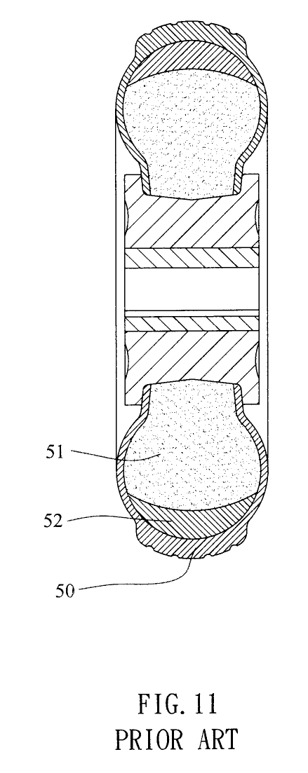

FIG. 9 shows that the resilient portion 30 includes multiple protrusions 32 extending radially outward therefrom and each of the protrusions 32 includes a hollow space defined therein. The hollow protrusions 32 are individually defined and do not communicate with the hollow space 31 so as to individually perform the bouncing feature. The resilient portion 30 is made by rubber or thermo-elastic rubber. The resilient portion 30 can be an oval cross section and an elongate and curved cross section.

The tire of the present invention is easily manufactured and the hollow resilient portion 30 reduces the material of the foam portion 20 requires and provides proper bouncing feature which can keep the shape of tire during operation.

While we have shown and described the embodiment in accordance with the present invention, it should be clear to those skilled in the art that further embodiments may be made without departing from the scope of the present invention.

What is claimed is:

1. A tire comprising:
a foam portion made of rubber or plastic material and being foamed integrally to be a ring-shaped foam portion, and
a resilient portion received in the foam portion and having a hollow space defined therein.

2. The tire as claimed in claim 1, wherein the resilient portion has a circular cross section.

3. The tire as claimed in claim 1, wherein the resilient portion has an oval cross section.

4. The tire as claimed in claim 1, wherein the resilient portion has an elongate and curved cross section.

5. The tire as claimed in claim 1, wherein the resilient portion includes multiple protrusions extending radially outward therefrom and each of the protrusions includes a hollow space defined therein.

6. The tire as claimed in claim 1, wherein the resilient portion 30 is made by rubber or thermo-elastic rubber.

7. A tire comprising:
a rubber portion located on an outer periphery of the tire;
a foam portion made of rubber or plastic material and being foamed integrally to be a ring-shaped foam portion, the foam portion received within a space enclosed by the rubber portion, and
a resilient portion received in the foam portion and having a hollow space defined therein.

8. The tire as claimed in claim 7, wherein the resilient portion has a circular cross section.

9. The tire as claimed in claim 7, wherein the resilient portion has an oval cross section.

10. The tire as claimed in claim 7, wherein the resilient portion has an elongate and curved cross section.

11. The tire as claimed in claim 7, wherein the resilient portion includes multiple protrusions extending radially outward therefrom and each of the protrusions includes a hollow space defined therein.

12. The tire as claimed in claim 7, wherein the resilient portion 30 is made by rubber or thermo-elastic rubber.
